(19) United States
(12) Patent Application Publication
(10) Pub. No.: US 2001/0009855 A1
(43) Pub. Date: Jul. 26, 2001

(54) Cost-sensitive control of data transfer involving a mobile entity

(76) Inventor: Colin I'Anson, Bristol (GB)

Correspondence Address: Paul D. Greeley, c/o Ohlandt, Greeley, Ruggiero & Perle, Suite 903, One Landmark Square, Stamford, CT, 06901, US

(21) Appl. No.: 09/770,074

(22) Filed: Jan. 25, 2001

(30) Foreign Application Priority Data
Jan. 26, 2000 (GB) 0001637.8

(51) Int. Cl. H04Q 7/20

(52) U.S. Cl. 455/445; 455/406

(57) ABSTRACT

A service system (40) receives transfer descriptors each specifying parameters of a desired data transfer to/from a mobile entity (20) over a cellular radio infrastructure (10). These parameters include a cost criterion. The service system (20) is responsible for determining the lowest cost way of effecting each required data transfer within the limits set by the corresponding transfer descriptor, and for initiating the transfer in accordance with this determination.

### FIELD OF THE INVENTION

The present invention relates to data transfers over a cellular radio infrastructure to/from a mobile entity and, in particular, to a service system and method for determining how and when data transfers can be effected within cost criteria specified for the transfers.

### BACKGROUND OF THE INVENTION

Communications infrastructures suitable for effecting data transfers to/from mobile users already exist. A typical such infrastructure comprises a cellular radio network providing a data-capable bearer service whereby a mobile entity associated with a user can communicate with data servers. FIG. 1 shows one form of known infrastructure in which a portable PC can transmit and receive data over a data-capable bearer service provided by a GPRS-enabled GSM PLMN (Public Land Mobile Network).

More particularly, the portable PC 24 communicates via interface 25 with a GSM cell phone 21, the PC and cell phone together forming a mobile entity 20. The interface 25 can, for example, be an infrared interface, a wire interface or a local RF interface. The cell phone 21 includes a radio subsystem 21 and a phone subsystem 22 which together provide a mobile phone capability. The cell phone 21 communicates via a radio link with the fixed part 10 of the GSM PLMN, this latter comprising one or more Base Station Subsystems (BSS) 11 and a Network and Switching Subsystem NSS 12. Each BSS 11 comprises a Base Station Controller (BSC) 13 controlling multiple Base Transceiver Stations (BTS) 14 each associated with a respective “cell” of the radio network. The NSS 12 comprises one or more Mobile Switching Centers (MSC) 15 together with other elements (not shown) such as Visitor Location Registers and Home Location Register. When the cell phone 21 is used to make a normal telephone call, a circuit is set up through the relevant BSS 11 to the NSS 12 which is then responsible for routing the call to the target phone (whether in the same PLMN or in another network).

The cell phone 21 also supports GPRS (see layer 23) enabling IP packet data to be passed via the radio subsystem 21 and the relevant BSS to a GPRS network 17 of the PLMN 10. The GPRS network 17 includes a SGSN (Serving GPRS Support Node) 18 interfacing BSC 14 with the network 17, and a GGSN (Gateway GPRS Support Node) interfacing the network 17 with an external network (in this example, the public Internet 39). Full details of GPRS can be found in the ETSI (European Telecommunications Standards Institute) GSM 03.60 specification. Using GPRS, the portable PC can exchange packet data via the cell phone 21, BTS 13, BSC 14, and GPRS network 17 with a server 30 connected to the public Internet 39 (this connection generally being through suitable firewall 32).

In FIG. 1, the portable PC 24 is shown running an e-mail client 26 with in-box 27 and outbox 28. The portable PC will generally be periodically connected via the GPRS data bearer service to an e-mail server at which time out-going e-mail data is uploaded from the outbox 28 to the server and incoming e-mail data is downloaded from the server to the in-box 27. The e-mail application is merely one example of a common need to transfer data between the mobile entity 20 and a server connected to the fixed network. Many other examples will be readily apparent—for example, instead of a portable PC, the mobile entity might include a digital camera arranged to upload image data to a server for storage. Again, the mobile entity could be a single device combining the cell phone with, for example, WAP (Wireless Application Protocol) functionality for running WAP applications. Details of WAP can be found, for example, in the book “Official Wireless Application Protocol” Wireless Application Protocol Forum, Ltd published 1999 Wiley Computer Publishing. Whilst the foregoing examples of a mobile entity include cell phone functionality, it is of course to omit this functionality if only data transfer is required to/from the mobile entity; in this case, the mobile entity (such as PDA) would include the radio subsystem and an appropriate data-capable bearer service layer, such as the GPRS layer in 23.

It will be appreciated that the FIG. 1 arrangement is only one possible arrangement of many for providing data-capable bearer services to mobile entities. For example, even within the GSM world, the bearer service rather than being GPRS, could be a basic circuit-switched bearer or could use the GSM short message service SMS. The cellular radio system could be any of the available systems though digital systems are to be preferred.

Many data transfer operations to/from a mobile entity are not time critical within a few hours. For example, e-mail is a store and forward system so that short delays are not a major issue. However, in many cases, the cost of using mobile data services are so high that it is not worthwhile implementing certain services that could otherwise be offered. Tariffs for data transfer are generally not monolithic and will vary according to the service provided (e.g. data rate) and time of day; also the tariff structure of different mobile networks differ as also do tariffs of different data-transfer service providers providing competing data-transfer services through the same infrastructure. As a result, some services that require data transfers which would not be viable if the most convenient (and likely most expensively priced) data-transfer service is used, may be viable if a less expensive tariff is chosen.

It is known to broadcast tariffs to mobile users to enable them to decide when to use the mobile network—see, for example, “Selective Broadcasting of Charge Rates”, A P B Vedel, Ericsson, Nov. 13, 1996, and “Load based priority for the Mobile Subscriber”, R Bhatia & G Borg, Ericsson, Oct. 8, 1998.

It is also known for a mobile system to make a time based decision about when it may communicate (see “Time Shared Multiple Unit Operation in a Communication System”, Y Damghani, Uniden, Oct. 25, 1995).

It is further known to take account of Quality of Service in deciding when to make a call (see “Apparatus and Method for Communications Control (QoS)”, R W Purnadi & L Hsu, Nokia, Mar. 26, 1998).

It is an object of the present invention to provide a system and method for facilitating cost-related determinations as to when to effect data transfers to/from mobile entities.

### SUMMARY OF THE INVENTION

According to the present invention, there is provided a method of cost-sensitive control of data transfer between a mobile entity and a data network through a cellular radio infrastructure, the method involving carrying out the following steps at a service system connected to the data network,

(a) receiving a transfer descriptor indicative of, at least in general terms, the end points of a required data transfer, and of transfer criteria, comprising at least a cost criterion, to be met by the data transfer;

(b) determining whether and, if so, how, the data transfer can be effected within the transfer criteria;

(c) where step (b) produces a positive determination, instructing initiation of the data transfer in accordance with that determination.

The transfer may be an upload of data to the mobile entity or a download of data. The transfer cost criterion will generally specify a maximum acceptable cost and step (b) will typically operate to determine the lowest cost consistent with all the transfer criteria. Apart from cost, the transfer criteria may specify characteristics such as data rate and maximum delay before transfer is effected.

The service system can determine whether the cost criterion is met in a number of ways. Typically, the tariff data for the cellular radio infrastructure may be pre-fetched or pre-loaded into the system (for example, by being pushed from a tariff server), or fetched when required. Also the service system may negotiate a price with the infrastructure and may even carry out an auction between competing infrastructures or between data-transfer service providers using the same or different infrastructures.

Initiation of data transfer can be effected by the service system notifying one endpoint of appropriate set up details or by having the infrastructure set up the data transfer. Alternatively, the data transfer may be effected through the service system for which purpose the data can be sent to the service system with the transfer descriptor and temporarily stored there until a data transfer path is set up to the mobile entity.

The transfer descriptor may relate to a once-off data transfer or to a transfer to repeated according a schedule.

Use of this method facilitates traffic regulation by the mobile operator since now real-time adjustment of tariffs can more readily affect traffic loadings.

### BRIEF DESCRIPTION OF THE DRAWINGS

A method and service-system, both embodying the present invention, for the cost-sensitive control data transfers to/from a mobile entity will now be described, by way of non-limiting example, with reference to the accompanying diagrammatic drawings, in which:

FIG. 1 is a diagram of a known communications infrastructure usable for transferring data to/from a mobile entity;

FIG. 2 is a diagram showing the communications infrastructure of FIG. 1 provided with a service-system for the cost-sensitive control of data transfers to/from a mobile entity;

FIG. 3 is a diagram of a transfer descriptor provided to the FIG. 2 service system for specifying a desired data;

FIG. 4 is a diagram showing a set of delay/cost functions defining a cost criterion for a desired data transfer; and

FIG. 5 is a diagram illustrating the main processing operations effected by the FIG. 2 service system in handling a data-transfer request specified by an corresponding transfer descriptor.

### BEST MODE OF CARRYING OUT THE INVENTION

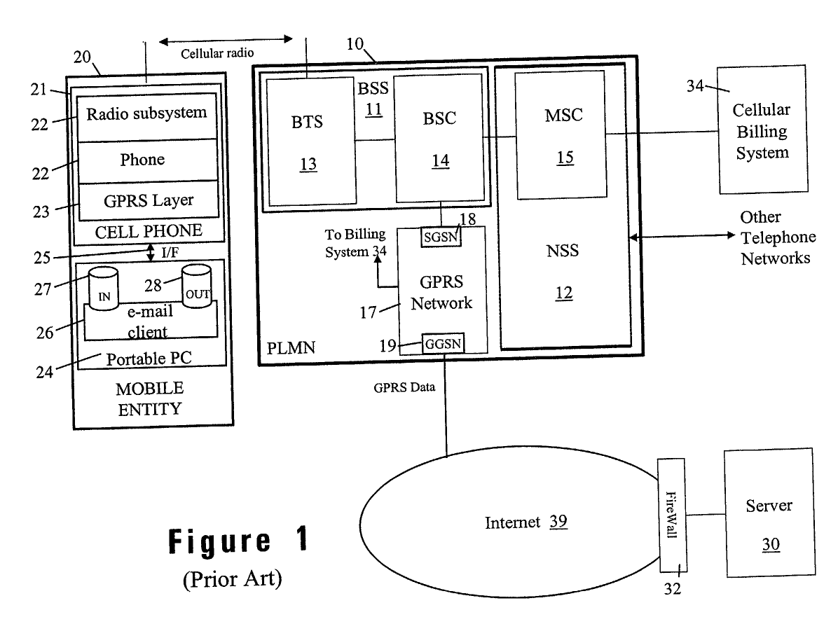

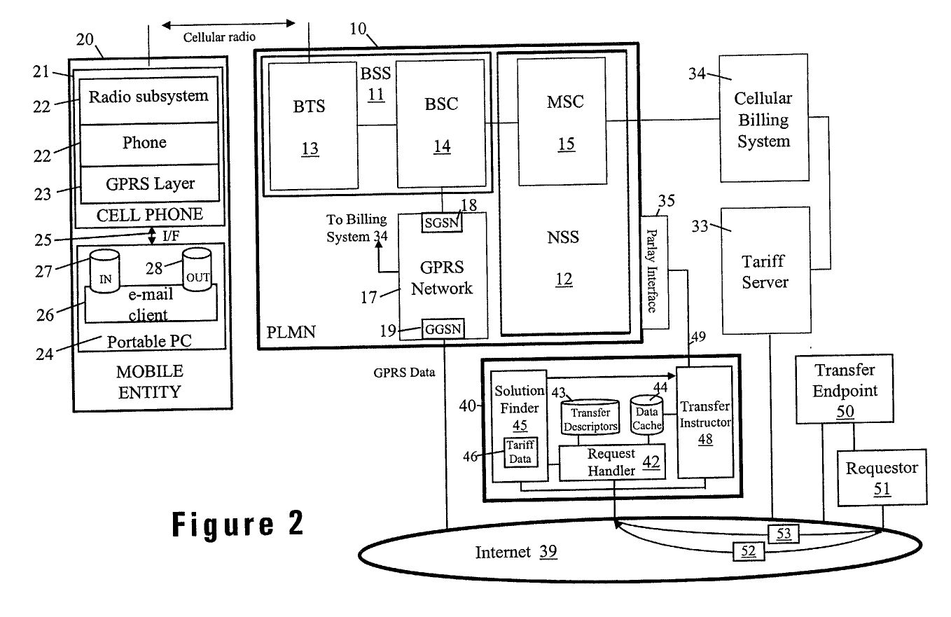

The service system and method embodying the invention, for the cost sensitive control of data transfers to/from a mobile entity will now be described with reference to FIG. 2 which shows the service system 40 as connected to the public Internet 39. It is to be understood that the present invention is not limited to the specifics of the mobile entity and communication infrastructure shown in FIG. 2 and the generalisations discussed above in relation to FIG. 1 regarding these elements apply equally to the operational context of the service system 40. Furthermore, whilst the service system 40 is shown as connected to the public Internet, it could be connected to the GPRS network 17 or to another fixed data network interfacing directly or indirectly with the network 17 or network 39.

In the FIG. 2 arrangement the PLMN 10 is shown as having a billing system 34 with an associated tariff server 33, this latter serving to publish to the Internet 39 the current tariffs for the various services provided by the PLMN operator, including the tariffs for various data transfer services (for example, data transfer via GPRS, data transfer by a normal voice traffic circuit (circuit switched data “CSD”), and data transfer by Short Message Service SMS—these latter two options not being explicitly shown in FIG. 2). The tariff for each service may vary according to time of day and according to the part of the network concerned (thus, transfers to/from individual cells may be differently priced); the tariffs may even be dynamically adjusted by the operator in response to current loading of the PLMN or any particular part of the latter.

The service system 40 is operative to receive requests for data transfers to/from mobile entities, determine how the request can be met within transfer criteria specified in the request, and then initiate the data transfer. A primary transfer criterion is cost and the service system is arranged to use the tariff data provided by the tariff server 33 in determining whether and how the cost criterion can be met (for example, if the cost criterion is simply to use the cheapest service, then the service system would select the lowest tariff service, subject to other transfer criterion being met). Where tariff data for future time periods is available, then the service system is arranged to consider these future tariffs when seeking to satisfy the transfer request, a solution then being specified in terms of the service to be used and when it is to be used (however, the transfer request may require the date transfer to be immediate in which case future tariffs are not considered).

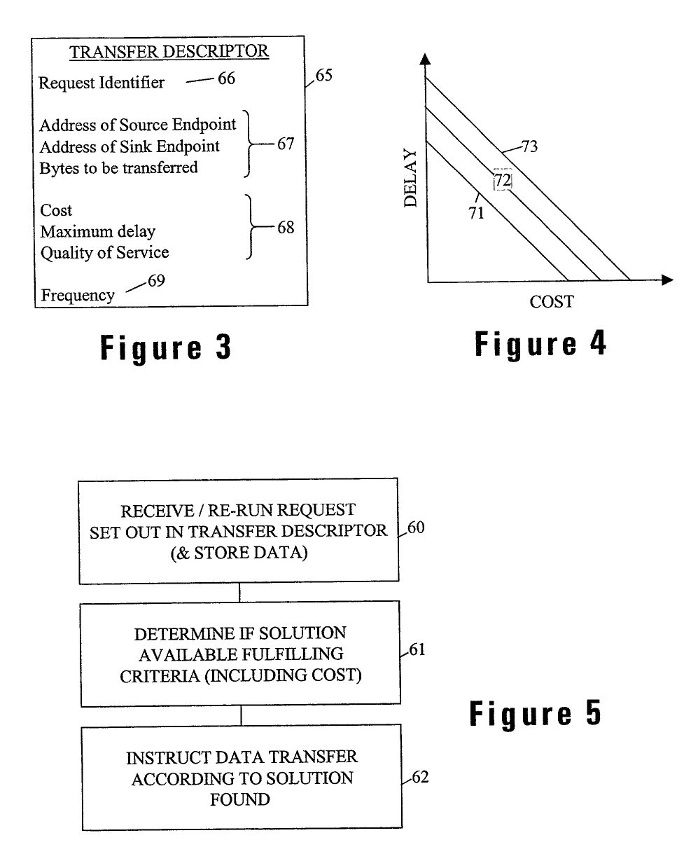

Transfer requests are specified to the service system in transfer descriptors. An example of one form of transfer descriptor 65 is depicted in FIG. 3. The transfer descriptor 65 starts with a Request Identifier 66 including a first element for identifying the entity requesting the data transfer (the “requester”) and a second element for identifying the request amongst other requests the requestor may have made. The transfer descriptor also comprises data elements 67 describing the data transfer (source and sink endpoint addresses, bytes to be transferred), and data elements 67 specifying criteria to be met by the transfer (cost, maximum delay before transfer started, quality of service). The form of the endpoint addresses will usually be sufficient to identity which endpoint is the mobile entity but this can also be explicitly indicated. Quality of service will usually be specified in terms of bit rate but other measures are also possible.

Finally, the transfer descriptor has a “frequency” data element 69 which specifies whether the request is a one-off request or whether the transfer is to be repeated—in this latter case, a transfer schedule is included (note that for repeated transfers, since the data content will generally vary between each transfer, it will usually not be possible to specify the number of bytes to be transferred).

With regard to the cost criterion, this can be specified in a number of ways. For example, the criterion could simply be to use the lowest cost solution or a tariff no greater than a specific figure. Alternatively, a maximum cost figure could be specified. The cost criterion may be specified as a function of delay before transfer is started—for example, the requestor may specify a delay-cost function such as represented by line 71 in FIG. 4. In this latter case, the requestor is willing to pay more for a smaller delay before transfer is effected; whilst any solution on or below line 71 is acceptable, the cost criterion may also specify that the cheapest acceptable solution is to be used. Of course, it may be that there exists no solution within the bounds of the delay-cost function represented by line 71; to deal with this, it is preferable to define a set of lines 71-73 with line 72 allowing a higher cost for a given delay than line 71 and line 73 allowing a still higher cost for that given delay. In this case, if no solution is found with line 71, the lines 72 and 73 are successively used for finding a solution.

The functional block structure of the service system 40 and its manner of operation will now be described in relation to a data transfer request generated by requestor 51 connected to the Internet 39. The requestor 51 makes a transfer request by sending a transfer descriptor 52 to the service system—typically, the requestor will already be registered as a user of the service system 40 though this is not essential. The data transfer that is the subject of the transfer request is, in the present example, the transfer of data from a transfer endpoint 50 connected to the network 39, to mobile entity 20 (the data to be transferred is, for example, e-mail destined for the in-box 27 of e-mail client 26). The requestor 51 is here shown as separate from the endpoint 50 but it could, of course, be part of the same entity.

The transfer descriptor 52 is received at the service system by a request handler 42 and stored in transfer-descriptor store 43. If the transfer descriptor concerns a one-off request or if the transfer descriptor concerns scheduled transfers the next one of which is due, the request is passed to a solution finder 45. For transfer descriptors related to scheduled transfers, the request handler maintains a consolidated schedule which it checks regularly and whenever a scheduled transfer comes up on the schedule as due, the corresponding descriptor is passed to the solution finder 45. In the FIG. 5 flow chart of the operation of the service system, the tasks performed by the request handles 42 correspond to step 60.

The role of the solution finder 45 is to find, for the data transfer specified by data elements 67 of the transfer descriptor, a data-transfer service and time that satisfies the transfer criteria specified by data elements 68 of the descriptor. For example, if the only criterion set is minimum cost, then the solution finder will retrieve tariff data from the tariff server and find the data-transfer service and time period offering the lowest available tariff. Of course, the solution finder will only consider future time periods if tariff data is available for such periods and the maximum delay criterion of the transfer descriptor is not set to zero. For convenience, the solution finder 45 may cache the retrieved tariff data in cache 46; however, care must be taken to only reference the cached data for its period of validity—where the tariffs are being dynamically changed by the operator in dependence on traffic loading, the period of validity of the retrieved tariff data may only be for the current enquiry. Alternatively, the tariff server may “push” tariff data to the solution finder 45 whenever the data changes. Where contractual arrangements have fixed the tariff structure for a particular user, then this tariff structure is preferably also stored in the solution finder for use whenever that user makes a data transfer request. The operation of the solution finder 45 corresponds to step 61 in FIG. 5.

With respect to dynamically-changing tariffs, it will not be possible to state exactly what these changing tariffs will be for any given future time period. However, an estimate can be given and the solution finder can be arranged to make its decisions on the basis of such estimates; in this case, the actual cost at the time the transfer is effected may differ from the estimate. A more certain approach is for the operator to publish future fixed tariffs which the service system can opt to take instead of the variable tariff. This requires both a reservation system by which the solution finder can book a certain capacity during a specified future time period at a given tariff, and an arrangement for correlating the data transfer when actually made with the booking.

If the solution finder 45 is unable to find a data transfer service and time period satisfying the transfer criteria contained in the transfer descriptor, the solution finder 45 reports this back to the request handler 42 which sends an appropriate response back to the requestor 51 and deletes the transfer descriptor from store 43 (where the descriptor relates to a series of scheduled transfers, the descriptor may be retained or deleted according to the policy being operated by the service system).

Where the solution finder 45 is successful in finding a solution, it passes the transfer descriptor and details of the solution (service, time period) to a transfer instructor block 48. The task of the transfer instructor 48 is to instruct initiation of the data transfer and this is can do in one of several ways:

the transfer instructor 48 can send a response message 53 to the requestor 51 with details of the service and time period to be used for the data transfer, it then being the responsibility of the requestor to effect the transfer in accordance with these details (in the present example, the requestor may at the appropriate time instruct the endpoint 50 to initiate a transfer to the mobile entity 20 using the appropriate data-transfer service);

the transfer instructor 48 can send a message to either endpoint with details of the service and time period to be used for the data transfer, it then being the responsibility of the endpoint to set up a data transfer path at the appropriate time using the appropriate data-transfer service;

the transfer instructor 48 can at the appropriate time command the PLMN 10 through control interface 35 to set up a data transfer path using the appropriate service between the end points (interface 35 may be a “Parlay” interface as described at http://parlay.msftlabs.com). In FIG. 2, the transfer instructor is shown as connected to the control interface 35 via dedicated link; however, the transfer instructor could communicate with interface 35 via the Internet 35.

In the first and second cases above, the transfer instructor 48 could delay sending out messages until the appropriate time for effecting the transfer.

Once the transfer instructor has carried out its operation in relation to a particular transfer request, the corresponding transfer descriptor is deleted from store 43 unless the latter relates to future-scheduled transfers. The operation of the transfer instructor corresponds to step 62 of FIG. 5.

In the foregoing example, it was requestor 51 which made the transfer request to the service system 40. It is also possible for either of the transfer endpoints 20, 50 to make the request regardless of the direction of the data transfer (though if the receiving endpoint of a data transfer makes the transfer request, it will generally not be able to specify in the transfer descriptor the number of bytes to be transferred).

The data transfer can be effected through the service system 40 itself. For example, where the entity making the transfer request to the service entity is a non-mobile data source endpoint, then at the same time as that entity passes the transfer descriptor to the service system, it can also send the service system the data to be transferred. In this case, the data is stored by the request handler 42 in a data cache 44 and the solution finder 45 looks for a data transfer solution from the service system to the mobile entity. Even if the data is not transferred to the service system at the time the transfer request is made, the data could still be subsequently transferred via the service system and, again, the solution finder is simply tasked to find a solution for the transfer leg involving the mobile (for example, where data is being uploaded from the mobile to a non-mobile data sink, the transfer can be effected by a first transfer leg from the mobile to the service system and a second leg from the service system to the data sink, the solution finder operating to find a solution for the first leg transfer). Where data is being moved into the service system as a result of a transfer operation initiated by the transfer instructor 48, it is the responsibility of the latter to control the caching of the data in data cache 44 and the subsequent transfer of the data to the destination data sink.

Other variants to the above-described service system are also possible. For example, rather than each transfer descriptor listing its set of transfer criteria, standard sets of criteria could be stored in store 43 and appropriately referenced by the transfer descriptors. Furthermore, with regard to the solution finder 45, the latter could be arranged to send an enquiry to the tariff server 33 asking whether the latter can provide a service satisfying the parameters set out in a transfer descriptor, the server 33 being operative to reply either positively with details of the service solution(s) available, or negatively where it cannot meet the transfer requirements. Again, provided the criteria specified in a transfer descriptor are sufficiently flexible, the solution finder 45 can be arranged to negotiate an optimum solution with the tariff server. Where there is the possibility of using more than one cellular radio infrastructure, or where there are several service providers offering data transfer services across the same (or different) infrastructure, then the solution finder can be arranged to consult all possible solution providers and even to carry out an auction between them for the data transfer concerned.

For the purposes of determining applicable tariffs, it may not be necessary for the service system to know the exact details of the transfer endpoints. For example, if the location of the mobile entity within the PLMN does not affect the applicable tariff, then the transfer descriptor does not need to include the precise details of the mobile entity for the solution finder to carry out its function (however, if the entity to be tasked with setting up the call is other than the initial requestor, then the details of the mobile entity will still be needed so that the transfer instructor 48 can appropriately instruct set up of the transfer).

It will be appreciated that although the above-described embodiment provides for considering data transfers at future times when the applicable tariffs may be less, it is possible, and indeed substantially less involved, only to consider currently applicable tariffs with solutions, where found, being implemented without delay.

1. A method of cost-sensitive control of data transfer between a mobile entity and a data network through a cellular radio infrastructure, the method involving carrying out the following steps at a service system connected to the data network,
(a) receiving a transfer descriptor indicative of, at least in general terms, the end points of a required data transfer, and of transfer criteria, comprising at least a cost criterion, to be met by the data transfer;
(b) determining whether and, if so, how, the data transfer can be effected within the transfer criteria;
(c) where step (b) produces a positive determination, instructing initiation of the data transfer in accordance with that determination.

2. A method according to claim 1, wherein the transfer descriptor complies with one of the following:
the transfer descriptor is supplied by a mobile entity and concerns downloading of data from the entity;
the transfer descriptor is supplied by a mobile entity and concerns uploading of data to the entity;
the transfer descriptor is supplied by a network-connected resource and concerns downloading of data from a mobile entity;
the transfer descriptor is supplied by a network-connected resource and concerns uploading of data to a mobile entity.

3. A method according to claim 1, wherein the cost criterion sets a maximum cost for effecting the data transfer.

4. A method according to claim 1, wherein the cost criterion specifies that the data transfer is to be effected at lowest cost consistent with the other transfer criteria, if any.

5. A method according to claim 1, wherein the cost criterion comprises a delay-dependent cost function for which the acceptable delay before transfer can be effected decreases with the maximum acceptable cost for the transfer, step (b) serving to determine the lowest cost at which the data transfer can be effected within a delay acceptable for that cost according to said cost function.

6. A method according to claim 1, wherein the cost criterion comprises a set of cost functions for each of which the acceptable delay before transfer can be effected decreases with the maximum acceptable cost for the transfer, successive cost functions of the set, other than a first cost function, having higher maximum acceptable cost for a given delay than a preceding cost function of the set, step (b) using each cost function in succession, starting with said first cost function, until a positive determination is made for effecting the data transfer at a cost which is within the function currently being used, this cost being the lowest cost at which the data transfer can be effected within a delay acceptable for that cost according to said cost function.

7. A method according to claim 1, wherein the transfer descriptor indicates that the data transfer is to be repeated according to a predetermined schedule, the method involving repeating steps (b) and (c) for that transfer descriptor according to said schedule.

8. A method according to claim 1, wherein said transfer criteria further comprise at least one of a minimum transfer bit rate and a maximum delay before transfer initiation.

9. A method according to claim 1, wherein the transfer descriptor references a predetermined set of transfer criteria accessible to the service system.

10. A method according to claim 1, wherein step (b) involves accessing tariff data for the cellular radio infrastructure, the tariff data being available through at least one of the following mechanisms:
pre-loaded into the service system from information provided off-line;
pre-fetched over the data network from a tariff server and stored at the service system;
fetched as needed over the data network from a tariff server;
provided by the infrastructure in response to a specific enquiry detailing the data transfer.

11. A method according to claim 1, wherein step (b) involves a negotiation conducted between the service system and a server representing the infrastructure.

12. A method according to claim 1, wherein step (b) involves specifying the required data transfer and the transfer criteria to a server representing the infrastructure and receiving back an indication of whether the infrastructure can effect the transfer as specified.

13. A method according to claim 1, wherein step (b) involves considering more than one cellular radio infrastructure for effecting the transfer and selecting the infrastructure that provides the lowest-cost fit with the transfer criteria.

14. A method according to claim 1, wherein step (b) involves considering multiple data-transfer service providers for effecting the transfer and selecting the service provider that provides the lowest-cost fit with the transfer criteria.

15. A method according to claim 1, wherein step (b) involves considering more than one cellular radio infrastructure for effecting the transfer and carrying out an auction between the infrastructures to determine which infrastructure is to be used.

16. A method according to claim 1, wherein step (b) involves considering both current and future data-transfer tariffs.

17. A method according to claim 1, wherein step (c) involves sending a message to one endpoint of the data transfer specifying the set up of data transfer by that endpoint in accordance with said determination effected in step (b).

18. A method according to claim 1, wherein step (c) involves the service system contacting the infrastructure to initiate data transfer set up by the infrastructure in accordance with the determination effected in step (b).

19. A method according to claim 1, wherein step (c) involves the service system effecting the data transfer through itself including by setting up a data transfer path with the mobile entity through the cellular radio infrastructure in accordance with the determination made in step (b).

20. A method according to claim 1, wherein the data transfer concerns a transfer of data to the mobile entity, the data to be transferred being passed to the service system along with the transfer descriptor where it is temporarily stored, step (c) involving initiating a transfer to the mobile entity, of the data temporarily stored at the service system.

21. A method of effecting real-time regulation of data traffic through a cellular radio infrastructure, comprising the steps of:
(i) effecting traffic-dependent changes to the tariff structure for data transfer through the infrastructure and making the current tariff structure accessible over to a data network; and
(ii) effecting the method of claim 1 using a service system connected to the data network referred to in step (i).

22. A service system with means for effecting each of the method steps of claim 1.
